(19) United States
(12) Patent Application Publication
(10) Pub. No.: US 2006/0109089 A1
(43) Pub. Date: May 25, 2006

(54) Sports timer actuation system

(76) Inventors: Travis A. Boehm, Indianapolis, IN (US); David Duffy, Westerville, OH (US); Daniel J. Frank, Cedar Rapids, IA (US); Thomas M. Heller, St. Paul, MN (US); Ben Huckaba, Palos Hills, IL (US); Alvin Ruth, Indianapolis, IN (US); LaMarr Taylor, Nashville, TN (US); Matthew Weyer, Fisher, IN (US)

Correspondence Address: Intellectual Property Group;Bose McKinney & Evans LLP, 2700 First Indiana Plaza, 135 North Pennsylvania Street, Indianapolis, IN, 46204, US

(21) Appl. No.: 10/995,976

(22) Filed: Nov. 23, 2004

(51) Int. Cl. G08B 27/00

(52) U.S. Cl. 340/326

(57) ABSTRACT

A sports timing system for timing periods of a sporting event is provided. The sports timing system includes a signaling device, a transmitter, a receiver, and a controller. The signaling device includes a pressure transducer. The pressure transducer generates a first signal when pressure is applied to the pressure transducer. The transmitter receives the first signal and generates a second signal. The receiver receives the second signal and generates a third signal. The controller receives the third signal and actuates a timer event.

### TECHNICAL FIELD OF THE INVENTION

The present invention is related to the field of timer actuation systems used in sports and sporting events.

### BACKGROUND AND SUMMARY OF THE INVENTION

Remote triggering of sport timing systems is known in the art, the most common being the use of a whistle to alert a human operator to initiate a timer event, such as stopping or starting a timer or game clock. That system includes several inaccuracies, such as inaccuracies in starting and stopping the timer caused by the failure or delay of the operator to hear the whistle blow in the presence of ambient noise.

### BRIEF DESCRIPTION OF THE DRAWINGS

FIG. 1 illustrates an exemplary timer stop system;

FIG. 2 illustrates an exemplary timer stop system utilizing multiple transmitter systems;

FIG. 3 illustrates an exemplary transmitter system of the timer stop system shown in FIGS. 1 and 2;

FIG. 4 is a schematic diagram of an exemplary embodiment of the transmitter system shown in FIGS. 1 and 2;

FIG. 5 illustrates an exemplary receiver system of the timer stop system shown in FIGS. 1 and 2;

FIG. 6 is a schematic diagram of an exemplary embodiment of the receiver system shown in FIG. 3;

FIG. 7 illustrates an exemplary embodiment of a whistle containing an embedded pressure transducer and a quick connect/disconnect cord that can attach to a transmitter;

FIG. 8 illustrates one embodiment of a retrofit sleeve that houses the pressure transducer and a quick connect/disconnect cord that can attach to a transmitter;

FIG. 9 illustrates another embodiment of a retrofit sleeve that houses the pressure transducer and a quick connect/disconnect cord that can attach to a transmitter; and

FIG. 10 is a flowchart of an exemplary embodiment of the method incorporating the apparatus described herein.

### DETAILED DESCRIPTION OF THE DRAWINGS

While the invention is susceptible to various modifications and alternative forms, exemplary embodiments thereof have been shown by way of example in the drawings and will herein be described in detail. It should be understood, however, that there is no intent to limit the invention to the particular forms disclosed, but on the contrary, the intention is to cover all modifications, equivalents, and alternatives falling within the spirit and scope of the invention as defined by the appended claims.

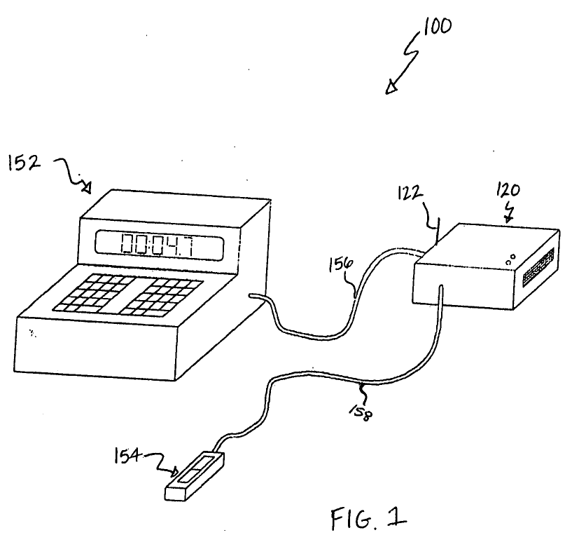

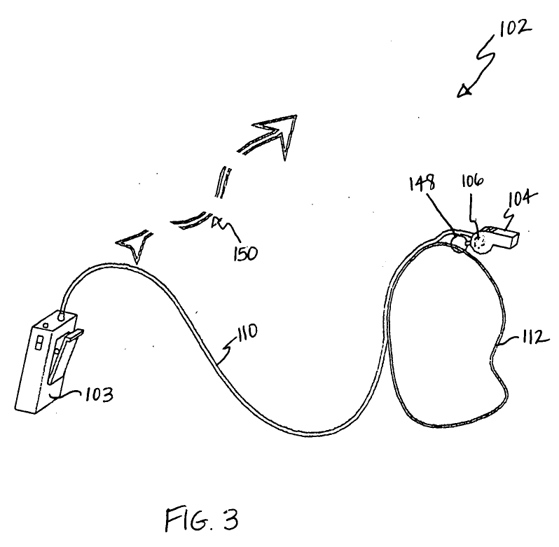

Referring first to FIGS. 1 and 3, a sports timer actuation system 100 including a signaling device 104 such as a whistle with an embedded pressure transducer 106 is shown. Embedded pressure transducer 106 is electrically connected to transmitter 103 by an appropriate electrical connection cable 110 or by an appropriate wireless protocol (not shown). In one embodiment, signaling device 104 is a whistle. An example of cable 110 is a standard 4, 6, or 8-conductor telephone cord, although any suitable cable can be used. Transmitter 103, in response to an electrical signal from pressure transducer 106, generates and transmits wireless signal 150. Lanyard 112 attaches to cable 110 with a connector ring 148. This allows the signaling device 104 to be carried around an officiant's neck, for example, via lanyard 112 when otherwise not in use.

Wireless signal 150 is received by receiver 120 through antenna 122. Antenna 122 may be either contained inside the case of receiver 120 or may be external to receiver 120. Receiver 120 interfaces with scoreboard controller 152 through scoreboard connection cable 156. In one embodiment, receiver 120 has connections (not shown) that allow a scoreboard remote control 154 to be connected to receiver 120 via scoreboard remote control connection cable 158. When utilizing scoreboard remote control 154, signals travel via cable 158 and pass through receiver 120 and into scoreboard controller 152 via cable 156. In another embodiment, scoreboard remote control 154 is not required and receiver 120 includes switches (not shown) that reproduce the signals that would otherwise be generated by scoreboard remote control 154.

In yet another exemplary embodiment, the transmitted signal 150 is encoded using, for example, “rolling code” security that is known in the art or a similar technology to send secure signals. In the rolling code embodiment, the receiver is configured to “learn” different codes for transmitter 103, so that only a transmitter 103 that has been configured to operate in conjunction with receiver 120 will be capable of actuating a timer event. Use of this method will significantly reduce the likelihood that other electronic devices operating within range of the receiver 120 would cause a false triggering of a timer actuation event.

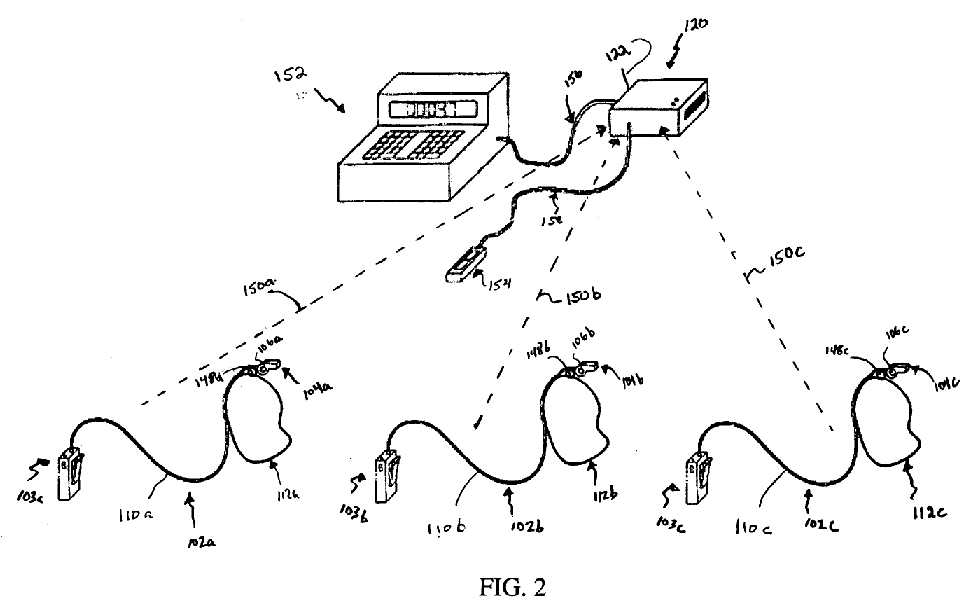

Referring now to FIG. 2, another embodiment of the sports timer actuation system 100 includes multiple transmitter systems 102a, 102b, and 102c. Each transmitter system 102 is similar to that shown in FIG. 3, including a signaling device 104 with pressure transducer 106, cable 110, transmitter 103, lanyard 112 and connector ring 148. In this embodiment, three transmitter systems are shown, but any number of transmitters 102 can be added based upon the needs of the particular event.

For example, in one exemplary embodiment, up to fifteen (15) transmitters 102 can be used to actuate the system. Each transmitter 103 sends a signal 150 that can be either identical or unique to that sent by the other transmitters 103. For example, signal 103a could be the same as signal 103b and signal 103c or a security protocol, such as the “rolling code” technology that is known in the art, could be employed so that each signal 103a, 103b, and 103c were unique. Receiver 120 is configured to accept signals 150 through antenna 122. Antenna 122 can be either internal or external to receiver 120.

In the encoded signal embodiment described above, the receiver is configured to “learn” the identity of each individual transmitter 103 prior to use during an event. For example, the officiants for an event could program their respective personal transmitter systems 102 by having the receiver learn to recognize each officiant's unique transmitter signal prior to the event. In another example, the person involved in preparing the equipment before the event could gather the required transmitter systems 103 and allow the receiver 120 to learn each one's signal to prepare it for the event.

Once receiver 120 has received an acceptable signal 150, it sends a timer actuation event signal to scoreboard controller 152 through cable 156. Manual control of the scoreboard controller 152 can be effectuated through the use of scoreboard remote control 154 that is connected to receiver 120 or through corresponding buttons or switches (not shown) integrated into receiver 120.

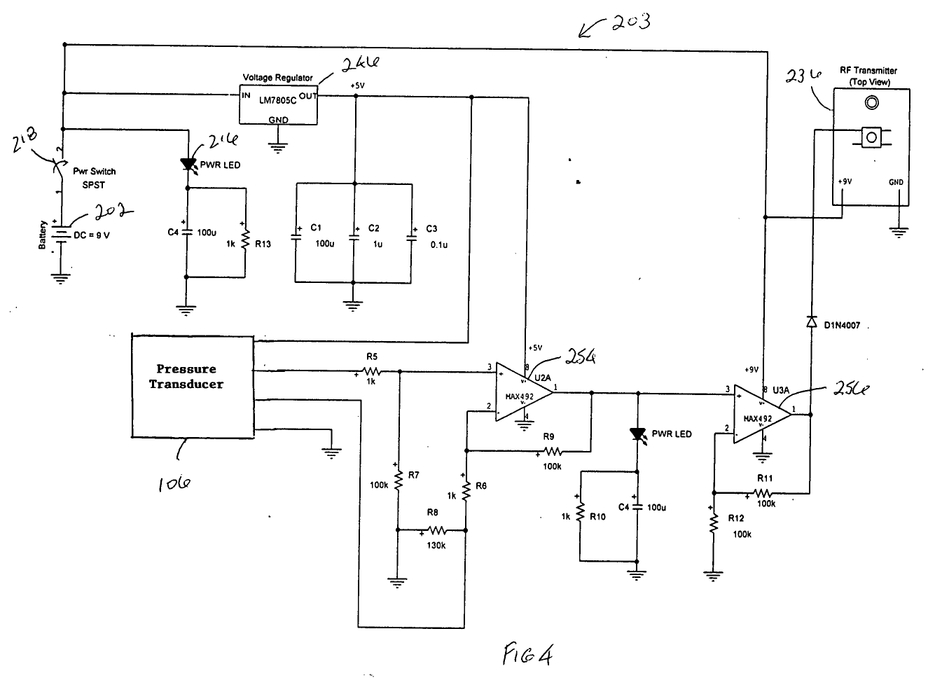

Referring now to FIG. 4, an exemplary embodiment of an electronic circuit 203 housed in transmitter 103 that includes RF transmitter 236 is shown. In one embodiment, RF transmitter 236 sends an encoded signal using “rolling code” technology. In another embodiment, RF transmitter 236 sends an unencoded signal. Transmitter circuit 103 is powered by a power source 202, such as a 9-volt battery. When engaged, power switch 218 causes the circuit to become energized and illuminates light emitting diode (LED) 216 to alert the operator that the transmitter is powered. In this example, voltage regulator 246 reduces the voltage across the pressure transducer 206 to 5 volts to bring the voltage within the proper operating range. Op amps 254 and 256 amplify the signal from the pressure transducer to a level that is sufficient to drive the RF transmitter 236 (9 volts in this exemplary embodiment).

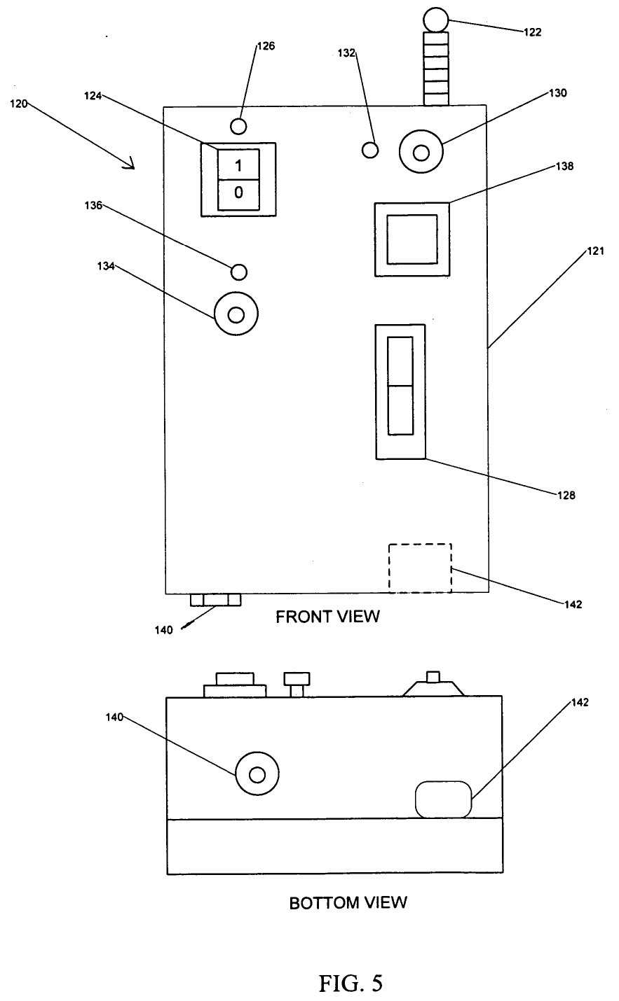

Referring now to FIG. 5, one exemplary embodiment of receiver 120 which includes receiver housing 121 is shown. Antenna 122 is electrically connected to receiver 120 and is shown in this example as being external to the receiver housing 121. However, in another embodiment, antenna 122 could be internally located within receiver housing 121. Power is supplied to receiver 120 from an external power source through receiver power connector 140. As an alternative, power could also be supplied via a battery (not shown) housed within housing 121. In this exemplary embodiment, receiver phone cord adapter 142 is a standard phone cord adapter and is used in conjunction with a standard phone cord as the means of connecting the receiver to the scoreboard controller 152. The scoreboard controller 152 is interfaced with receiver 120 through a cable 156 which connects at adapter 142.

In this exemplary embodiment, receiver 120 is equipped with several switches and indicators to control the functionality of the sports timer actuation system and to replace the functionality of the scoreboard remote control 154 described earlier in the specification. Power is supplied through switch 124. Indicator 126 indicates that the receiver electronics are energized. In the exemplary embodiment described above utilizing “rolling code” technology, learn switch 130 is provided to engage the learning mode of the receiver electronics to identify a desired transmitter 103 or transmitters 103 (not shown). When the learning mode is engaged, learn indicator 132 designates that the receiver is in learning mode and relates information specific to the RF receiver utilized

Start/stop switch 128, horn switch 138, reset switch 134 and reset indicator 136 are included in this exemplary embodiment to provide the functionality of the scoreboard remote control 154 described previously. Start/stop button 128 initiates a signal to the scoreboard controller 152 to alternatively start or stop the timer. Horn button 138 signals the scoreboard controller 152 described previously to sound the horn (not shown). In one exemplary embodiment, the reset indicator 136 illuminates after a timer actuation event to indicate to the operator that the scoreboard timer has been stopped by a timer actuation event. In this exemplary embodiment, the scoreboard timer is restarted upon engagement of reset button 134.

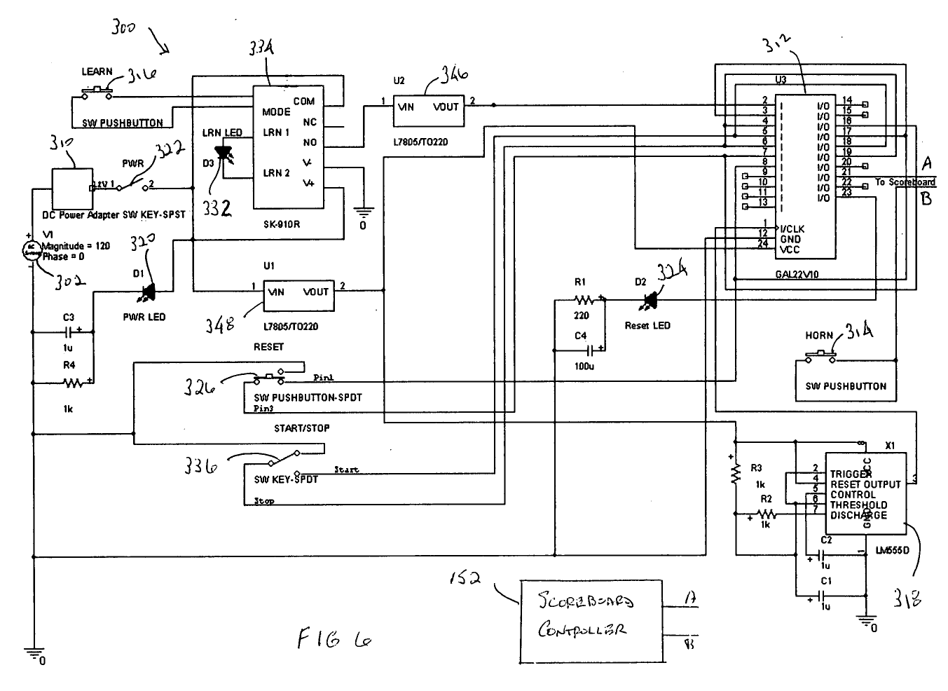

As shown in FIG. 6, receiver circuit 300 is housed in receiver 120. The circuit 300 converts a 120 VAC input 302 into 12 VDC through power supply 310 to supply required power to the circuit. When power switch 322 is engaged, power LED 320 illuminates to indicate that receiver circuit 300 has been energized. In this exemplary embodiment, voltage regulator 346 and voltage regulator 348 convert the 12 VDC current into 5 VDC current for square wave generator 318 and integrated circuit 312, respectively. In this exemplary embodiment, integrated circuit 312 is a GAL22V10 although any other suitable integrated circuit could be used. Square wave generator 318 supplies a square wave that causes integrated circuit 312 to operate as a state machine. To “teach” the receiver 120 to recognize different transmission signals 150, learn button 316 is engaged for several seconds until the learn indicator 332 blinks repeatedly. At this point the desired transmission signal should be generated.

In this exemplary embodiment, when an acceptable signal is received by RF receiver 334, a timer actuation event occurs that causes the circuit to send a signal to the scoreboard controller 152 to stop the timer and causes the reset LED (not shown) to illuminate. The voltage across the circuit remains at a high level until reset button 326 is engaged, an event that signals the scoreboard clock to restart and the reset LED (not shown) to turn off. If start/stop switch 336 is engaged, a signal is sent to the scoreboard controller 152 to either start or stop the timer, depending upon its current state. Similarly, if the horn switch 314 is engaged, a signal is sent to scoreboard controller 152 to sound the scoreboard horn (not shown).

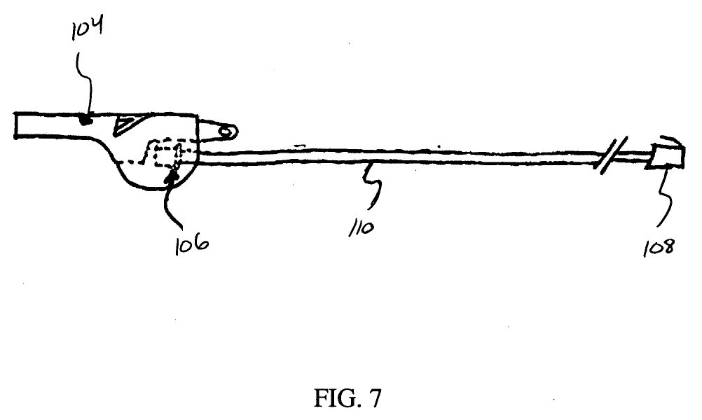

As shown in FIG. 7, one exemplary embodiment of a portion of the transmitter system 102 consists of a whistle 104 with an embedded pressure transducer 106 that is situated within the whistle to detect changes in pressure as the whistle is blown. Pressure transducer 106 is attached to a cable 110 that terminates in a quick connect/disconnect adapter 108, illustrated in this embodiment as a phone jack connector.

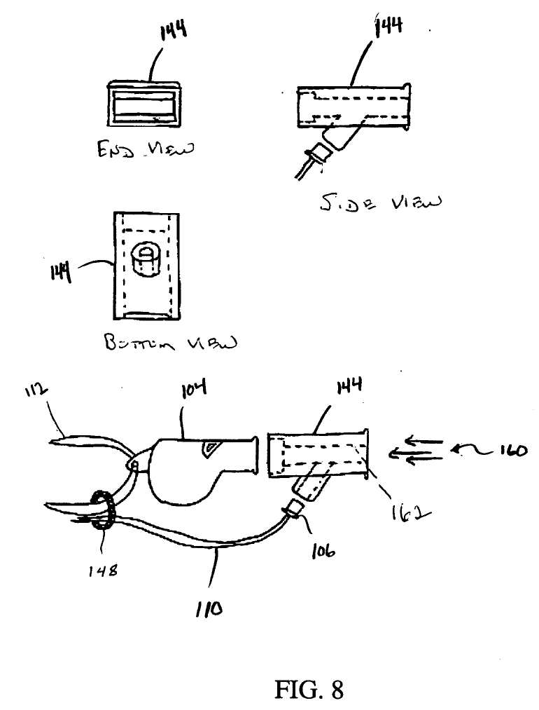

Another embodiment of the signaling device is shown in FIG. 8 and consists of a whistle 104 that is connected to a lanyard 112. A sleeve 144 is shaped to correspond with the shape of the whistle and allow the passage of air in direction 160 through the opening 162 in the sleeve and into the whistle. Sleeve 144 has a pressure transducer 106 integrated into it to sense the pressure changes of the air flowing through sleeve 144 and into whistle 104. Pressure transducer 106 is electrically connected to cable 110 to connect to the transmitter (not shown).

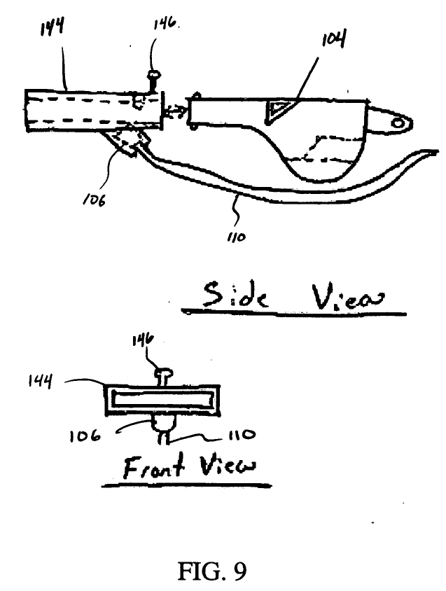

A further exemplary embodiment of the signaling device is shown in FIG. 9 and consists of a sleeve 144 that attaches to whistle 104 and is held in place by set screw 146. Pressure transducer 106 mounts within sleeve 144 to sense pressure changes within sleeve 144 and whistle 104 and generates a signal that is sent through cable 110 to the transmitter (not shown).

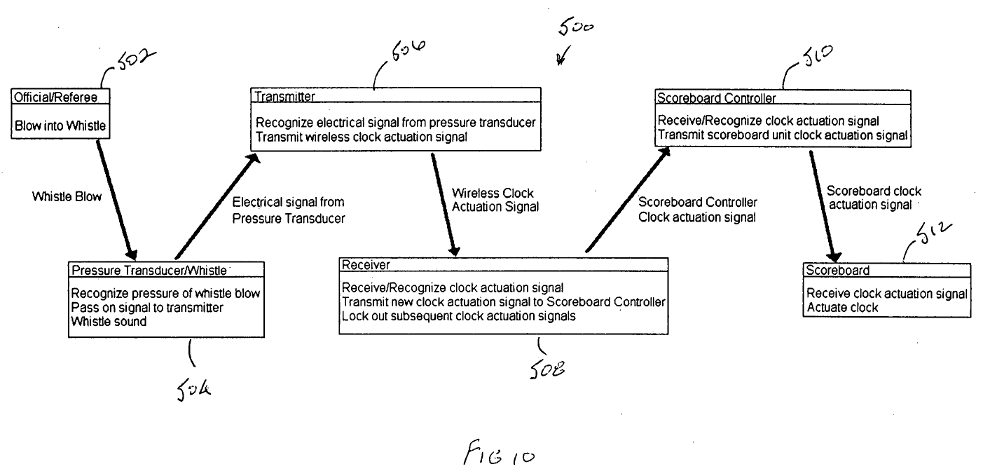

FIG. 10 is a chart 500 showing the flow of steps in the operation of the sports time actuation system 100 shown in FIGS. 1, 2 and 3. The first step 502 is an official blowing a whistle 104. The second step 504 includes the recognition of pressure resulting from passage of air from blowing the whistle 104, generation of a signal to be transmitted, and the whistle producing a sound. The third step 506 is the transmission of a signal from transmitter 103 to the receiver 120. Step four 508 is receiving the signal from the transmitter 103, transmitting a new actuation signal to the scoreboard controller 152 and locking out subsequent clock actuation signals. In step five 510 the scoreboard controller 152 receives and recognizes the clock actuation signal and transmits a clock actuation signal. Finally, in step six 512, the scoreboard receives the clock actuation signal and actuates a timer event at the clock.

While the invention has been illustrated and described in detail in the drawings and foregoing description, such illustration and description is to be considered as exemplary and not restrictive in character, it being understood that only exemplary embodiments have been shown and described and that all changes and modifications that come within the spirit of the invention and the attached claims are desired to be protected.

What is claimed is:

1. A sports timing system for timing periods of a sporting event, the sports timing system including:
a signaling device including a pressure transducer configured to generate a first signal when pressure is applied to the pressure transducer;
a transmitter configured to receive the first signal and generate a second signal;
a receiver configured to receive the second signal and generate a third signal; and
a controller configured to receive the third signal and actuate a timer event.

2. The sports timing system of claim 1, wherein the signaling device is a whistle.

3. The sports timing system of claim 1, wherein the signaling device is a sleeve configured to attach to a whistle.

4. The sports timing system of claim 1, further including a timer.

5. The sports timing system of claim 1, wherein the timer event is the starting of the timer.

6. The sports timing system of claim 1, wherein the timer event is the stopping of the timer.

7. The sports timing system of claim 1, further including another controller for manually actuating a timer event.

8. The sports timing system of claim 1, wherein upon actuation of a first timer event, manual intervention is required before the receiver will transmit the third signal to allow the actuation of subsequent timer events.

9. The sports timing system of claim 8, further including a button for the manual intervention.

10. The sports timing system of claim 1, wherein upon actuation of a first timer event, manual intervention is required before the timer will allow the reception of a subsequent third signal to actuate a timer event.

11. The sports timing system of claim 10, further including a button for the manual intervention.

12. The sports timing system of claim 1, further including an adjustable threshold at which the timer event is actuated.

13. The sports timing system of claim 1, wherein the second signal is encoded to prevent other signals present in the environment from erroneously actuating a timer event.

14. The sports timing system of claim 1, wherein a plurality of signaling devices having respective transmitters communicate with one receiver using encoded signals.
